(19) United States
(12) Patent Application Publication
(10) Pub. No.: US 2017/0350545 A1
(43) Pub. Date: Dec. 7, 2017

(54) PIPELINE FITTING WITH VIBRATION COMPENSATOR

(71) Applicant: ABORRA AG, Unterengstringen (CH)

(72) Inventors: Resat CIVELEK, Ruschlikon (CH); Fredy REICHEN, Emmenbrucke (CH)

(73) Assignee: ABORRA AG, Unterengstringen (CH)

(21) Appl. No.: 15/614,912

(22) Filed: Jun. 6, 2017

(30) Foreign Application Priority Data
Jun. 7, 2016 (CH) 00724/16

(51) Int. Cl. F16L 27/11; F16L 19/02; F16J 15/52

(52) U.S. Cl. CPC F16L 27/11; F16J 15/52; F16L 19/0218

(57) ABSTRACT

A pipeline fitting, which comprises connection support elements and can be easily installed and removed, for indirectly connecting a first pipe connection to a second pipe connection. Compression joints between the first and second connection support elements of the pipeline fitting and a first and a second compression joint flange on a first and a second compression joint connector can be produced in the longitudinal direction of the pipeline fitting. This is achieved in that the pipeline fitting features a vibration compensator with an elastic bellows, as well as a respective tubular fitting section and a sealing ring integrally formed thereon to both sides of the bellows in the longitudinal direction, wherein the sealing ring can be clamped between a connecting flange of the connection support element and the compression joint flange of the compression joint connector.

### TECHNICAL FIELD

The present invention describes a pipeline fitting, which comprises connection support elements, for indirectly connecting a first pipe connection to a second pipe connection, wherein compression joints between the first and second connection support elements of the pipeline fitting and a first and a second compression joint flange on a first and a second compression joint connector can be produced in the longitudinal direction of the pipeline fitting, and wherein the first and the second connection support elements respectively can be permanently pressed against the first and the second compression joint flanges by means of a union nut, with the invention furthermore describing a pressfitting system comprising a pipeline fitting according to one of the preceding claims, as well as a first and a second pipe connection.

### PRIOR ART

Different variations of pipeline fittings or pipeline joints for connecting pipelines have been used for quite some time. Nowadays, pressfittings represent the predominant connecting technique in commercial plumbing. In the meantime, numerous variations of pressfittings are known. They typically feature a compression sleeve, which is radially deformed by means of a pressing tool, such that the end of the pipe connection surrounded by the compression sleeve is pressed against a support body of the fitting and sealed. Compression joints between such pressfittings and a copper pipe, steel pipe or multilayer composite pipe are produced by means of compression pliers. This pressing tool ensures that a pipe connection is inseparably mounted on a pipeline fitting, wherein permanent fluid-tight connections can thereby be produced.

The advantages of these comparatively expensive fittings can be seen in the time savings and the simple installation. If do-it-yourselfers also want to use these pipeline fittings, they first have to procure corresponding pipeline fittings and the suitable pressing tool. Since the pressing tools and their pressing jaws are respectively adapted to the pipe ends and pipeline fittings to be connected, brand-compatible pressing tools, for example of the firms Geberit, Nussbaum, Viega, Klauke or Novopress, are required for compressing corresponding variations of pipeline fittings.

In addition to the problems of requiring pressing tools, which are adapted to the pipeline fittings, and no longer being able to remove the pipeline fittings after their installation, it is likewise disadvantageous that an insufficient and impermanent seal is occasionally produced between the pipeline fittings and the pipelines. Until now, it was also hardly possible to produce a flexible pipe joint for absorbing pipe expansions, pipe deviations, vibrations and noises because the connection should be realized as mechanically stable as possible.

### DISCLOSURE OF THE INVENTION

The present invention is based on the objective of developing a pipeline fitting and a pressfitting system, wherein the pipeline fitting can be easily and removably installed, and wherein no special brand-compatible pressing tools are required for the installation. It should be possible to produce a fluid-tight connection between the pipelines such that an absorption of pipe expansions, vibrations and noises is additionally achieved. The pipeline fitting and the pressfitting system respectively make it possible to realize an electrical decoupling, as well as an acoustical decoupling, between the pipelines.

This objective is attained by means of a pipeline fitting with the characteristics of claim 1.

The inventive pipeline fitting features an elastic vibration compensator and can be installed and removed with commercially available tools.

A pressfitting system, which is adapted to the pipeline fitting, is disclosed in claim 7.

### BRIEF DESCRIPTION OF THE DRAWINGS

Other characteristics, details and advantages of the invention can be gathered from the following description of preferred embodiments of the invention with reference to the drawings. In these drawings,

FIG. 1 shows a longitudinal view with a partial longitudinal section through a pipeline fitting between a first pipe connection and a second pipe connection, and

FIG. 2 shows a detailed section through the transition from the first pipe connection to the pipeline fitting.

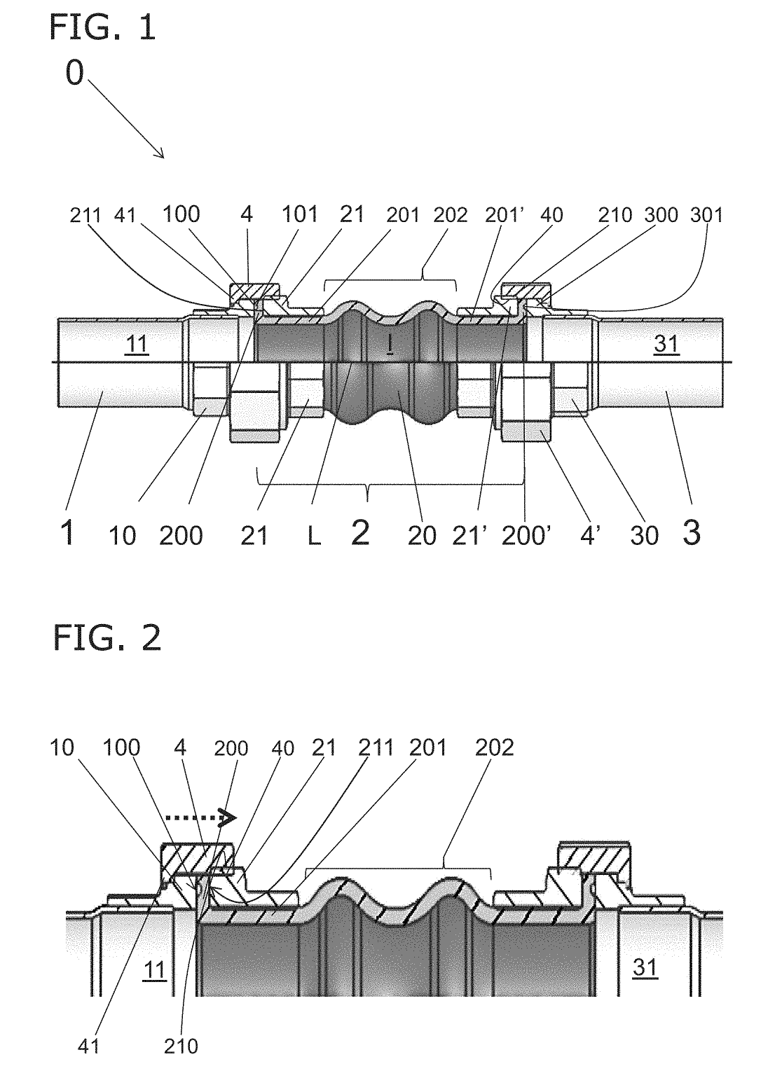

### DESCRIPTION

A pressfitting system 0 comprising a first pipe connection 1 and a second pipe connection 3, which are indirectly connected by means of a pipeline fitting 2 or a pipeline joint, is described in greater detail below. In this case, the pipeline fitting 2 can be installed on and removed from the pipe connections 1, 3 due to the construction of the pipeline fitting 2. The pipeline fitting 2 extends in the direction of a longitudinal axis L between the pipe connections 1, 3. Corresponding means for mounting the pipeline fitting 2 are arranged on the pipe connections 1, 3.

The pipeline fitting 2 comprises a vibration compensator 20 that is realized in one piece and made of an elastic material, preferably a rubber-based material. The vibration compensator 20 essentially has a cannular or tubular design with an interior I. Connection support elements 21, 21′ are respectively arranged on the edge regions of the vibration compensator 20 as parts of the pipeline fitting 2.

The vibration compensator 20 is formed by an elastic bellows 202, which is particularly realized in the form of a multiple bellows 202 in this case, as well as respective tubular fitting sections 201, 201′ and sealing rings 200, 200′ on the ends. The tubular fitting section 201, 201 is encompassed by the connection support element 21, 21′ outside the interior I whereas the multiple bellows 202 is exposed. The multiple bellows 202 is realized in the form of a double bellows in this case. The compression joint is produced in the region of the tubular fitting sections 201, 201′ and the sealing rings 200, 200′ and therefore in the edge regions of the vibration compensator 20. The sealing rings 200, 200′ radially extend away from the longitudinal axis L at a right angle.

The connection support elements 21, 21′ are realized annularly and surround the tubular fitting sections 201, 201′ in the edge regions at a radial distance from the longitudinal axis L of the vibration compensator 20. The connection support elements 21, 21′ may be integrally mounted in the edge regions of the vibration compensator 20, particularly by means of bonding or welding, outside the interior I on the outer wall.

External threads 210 are respectively arranged on the sides of the connection support elements 21, 21′, which face away from the tubular fitting sections 201, 201′, such that they extend away from the tubular fitting sections 201, 201′. Connecting flanges 211 are arranged on the connection support elements 21, 21′ such that they extend outward in the direction of the longitudinal axis L.

In this case, union nuts 4, 4′ are used in the edge regions of the pipeline fitting 2 in order to respectively produce a compression joint between the face sections of the pipeline fitting 2 and the first and the second pipe connections 1, 3. The union nuts 4, 4′ are realized in the form of hexagon nuts in this case and respectively feature an internal thread 40. An edge 41 extending in the direction of the longitudinal axis L is integrally formed on each union nut 4, 4′. On this edge, the union nut 4, 4′ pulls the first pipeline 11 in the direction of the bellows 202 such that a fluid-tight connection can be produced. However, the embodiment may also be modified in such a way that the pipeline fitting 2 is pulled in the direction of the first pipeline 11 and/or the second pipeline 31.

The ends of the pipe connections 1, 3 are equipped with inseparable first and second compression joint connectors 10, 30 that extend in the direction of the pipeline fitting 2. In this case, the compression joint connectors 10, 30 concentrically surround the first and the second pipeline 11, 31 and have a polygonal shape on their outer sides. On the faces that point toward the pipeline fitting 2, the compression joint connectors 10, 30 respectively feature a compression joint flange 100, 300, into which a concentric circumferential rib 101, 301 is integrally formed in this case.

In order to produce a fluid-tight connection between the first pipeline 11 and the second pipeline 31 by means of the pipeline fitting 2, the first and the second compression joint connectors 10, 30 are flanged on the connection support elements 21, 21′. For this purpose, the first pipe connection 1 is attached to the sealing ring 200 of the vibration compensator 20 with its first compression joint connector 10. During this process, the compression joint flange 100 is pressed on the sealing ring 200 in the direction of the connecting flange 211 of the connection support element 21. The sealing ring 200 is squeezed between the compression joint flange 100 and the connecting flange 211. In this case, the compression joint is produced due to the flanging in the direction of the longitudinal axis L.

The union nut 4 is pushed over the flange section in order to realize this flanging permanently, wherein the internal thread 40 of the union nut 4 cooperates with the external thread 210 of the connection support element 21. The edge 41 of the union nut 4 presses the first compression joint connector 10 in the direction of the connection support element 21 as indicated by the arrow drawn with broken lines. A fluid-tight connection is produced after the flanging process, wherein the union nut 4 can be tightened with a simple, commercially available tool. Due to the respective elasticity of the vibration compensator 20 and the sealing ring 200, the connection can also be separated again and produced anew, wherein a fluid-tight connection can always be produced. A slight deformation of the sealing ring 200 takes place during the compression process, wherein the pipeline fitting 2 can be easily replaced.

In this case, the circumferential rib 101 in the form of a raised sealing rib is additionally provided on the compression joint flange 100. This circumferential rib 101 is partially pressed into the opposing elastic sealing ring 200 during the flanging process such that a fluid can be permanently prevented from escaping from the interior I.

No special tools are required due to the simple screw-on design of the union nuts 4, 4′ for producing the flange connection. The seal of the interior I is optimized due to the design of the sealing rings 200.

In this case, the vibration compensator 20 is realized in one piece and made of a rubber material, particularly a synthetic rubber such as nitrile rubber, chloroprene rubber or ethylene-propylene-diene rubber. The vibration compensator 20 absorbs mechanical vibrations, for example in the form of sound, which may originate from the first and second pipelines 10, 30. An electrical decoupling can likewise be realized due to the use of the electrically non-conductive rubber material.

Since the connection support elements 21, 21′ and the compression joint flanges 100, 300 of the compression joint connectors 10, 30 squeeze the sealing rings 200, 200′, the connection support elements 21, 21′ only can be arranged such that they are separably slipped over the tubular fitting sections 201, 201′.

List of Reference Symbols

| 0 | Pressfitting system | | |
|---|---|---|---|
| 1 | First pipe connection | | |
| | 10 | First compression joint connector | |
| | | 100 | Compression joint flange |
| | | 101 | Circumferential rib/raised sealing |
| | | | projection |
| | 11 | First pipeline | |
| 2 | Pipeline fitting (removable) | | |
| | 20 | Vibration compensator (elastic) | |
| | | 200 | Sealing ring |
| | | 201 | Tubular fitting section |
| | | 202 | Elastic bellows (multiple bellows) |
| | 21 | Connection support element (annular) | |
| | | 210 | External thread |
| | | 211 | Connecting flange |
| | L | Longitudinal axis | |
| 3 | Second pipe connection | | |
| | 30 | Second compression joint connector | |
| | | 300 | Compression joint flange |
| | | 301 | Circumferential rib/raised sealing |
| | | | projection |

| | 31 | Second pipeline |
|---|---|---|
| 4 | Union nut | |
| | 40 | Internal thread |
| | 41 | Edge |

1. A pipeline fitting, which comprises connection support elements, for indirectly connecting a first pipe connection to a second pipe connection, wherein compression joints between the first and second connection support elements of the pipeline fitting and a first and a second compression joint flange on a first and a second compression joint connector can be produced in the longitudinal direction of the pipeline fitting, and wherein the first and the second connection support elements respectively can be permanently pressed against the first and the second compression joint flanges in the longitudinal direction by a union nut,
wherein
the pipeline fitting features a vibration compensator with an elastic bellows, as well as a respective tubular fitting section and a sealing ring integrally formed thereon to both sides of the bellows in the longitudinal direction, wherein the sealing ring can be clamped between a connecting flange of the connection support element and the compression joint flange of the compression joint connector, and wherein the union nut produces a functional connection between the compression joint flange and the connection support element and ensures a separability of the flange connection.

2. The pipeline fitting according to claim 1, wherein the vibration compensator is realized in one piece and made of a rubber material, particularly a synthetic rubber such as nitrile rubber, chloroprene rubber or ethylene-propylene-diene rubber.

3. The pipeline fitting according to claim 1, wherein the connection support elements are integrally mounted in the edge regions of the vibration compensator such that they surround the tubular fitting sections, namely outside the interior on the outer wall, particularly by bonding, welding or vulcanizing.

4. The pipeline fitting according to claim 1, wherein the sealing rings are arranged such that they radially extend away from the longitudinal axis of the tubular fitting sections at a right angle.

5. The pipeline fitting according to claim 1, wherein the bellows is realized in the form of a multiple bellows, particularly a double bellows.

6. The pipeline fitting according to claim 1, wherein the respective sealing ring is elastically deformable in such a way that a circumferential rib on the compression joint flange can be pressed into the sealing ring.

7. A pressfitting system comprising a pipeline fitting according to claim 1, a first pipe connection and a second pipe connection, wherein
the first compression joint connector has a compression joint flange and the second compression joint connector has a compression joint flange, wherein said compression joint flanges are respectively equipped with a circumferential rib such that these circumferential ribs can be engaged with the sealing rings.

8. The pressfitting system according to claim 7, wherein the union nut has an internal thread that can be screwed on and thereby functionally connected to the external thread of the connection support element, wherein an edge of the union nut presses the compression joint flange of the compression joint connector in the direction of the connection support element parallel to the longitudinal axis such that the sealing ring is elastically deformed and holds the compression joint flange in position.
